(19) United States
(12) Patent Application Publication
(10) Pub. No.: US 2024/0336536 A1
(43) Pub. Date: Oct. 10, 2024

(54) METHOD FOR PRODUCING COATED SUBSTRATES, COATED SUBSTRATE, AND USE THEREOF

(71) Applicant: FRAUNHOFER-GESELLSCHAFT ZUR FÖRDERUNG DER ANGEWANDTEN FORSCHUNG E.V., München (DE)

(72) Inventors: Kevin SCHUCK, Erlangen (DE); Christian REIMANN, Erlangen (DE); Jochen FRIEDRICH, Erlangen (DE)

(73) Assignee: FRAUNHOFER-GESELLSCHAFT ZUR FÖRDERUNG DER ANGEWANDTEN FORSCHUNG E.V., München (DE)

(21) Appl. No.: 18/293,910

(22) PCT Filed: Aug. 1, 2022
(86) PCT No.: PCT/EP2022/071556

§ 371 Date: Jan. 31, 2024

(30) Foreign Application Priority Data
Aug. 3, 2021 (EP) 21189477.9

(51) Int. Cl. C04B 41/45; C04B 41/00; C04B 41/50; C04B 41/87

(52) U.S. Cl. CPC C04B 41/4539; C04B 41/0072; C04B 41/5057; C04B 41/87; C04B 2235/6567

(57) ABSTRACT

The invention relates to a method for producing coated substrates. In the method, an aqueous suspension is first produced which contains water, at least one agglomerate former, and particles of at least one refractory metal carbide, said particles of the at least one refractory metal carbide forming agglomerates in the aqueous suspension. The at least one aqueous suspension is then applied onto a porous substrate, and the substrate then undergoes a sintering process. According to the invention, the diameter of each agglomerate is greater than the pore entrance diameter of each pore of the porous substrate. The invention additionally relates to a coated substrate which is produced or can be produced using the method according to the invention and to the use of such a coated substrate.

The present invention relates to a method for preparing coated substrates. In the method, an aqueous suspension comprising water, at least one agglomerate former, and particles of at least one refractory metal carbide is first prepared, wherein the particles of the at least one refractory metal carbide form agglomerates in the aqueous suspension. Then, the at least one aqueous suspension is applied to a porous substrate. The substrate is then subjected to a sintering process. According to the invention, the diameter of each of the agglomerates is larger than the pore entrance diameter of each of the pores of the porous substrate. The present invention further relates to a coated substrate which may be produced or be producible by the method of the invention, and to the use of such a coated substrate.

Refractory metal carbides such as tantalum carbide (TaC) are generally characterized by their high mechanical, chemical and thermal resistance. The use of these materials focuses primarily on high-temperature applications, e.g. in semiconductor crystal growing, in which highly corrosive and aggressive species are present, thus limiting the usability of the existing component (e.g. made of graphite) or significantly reducing its service life. Since it is proving difficult to produce a proven volume component from refractory metal carbides at low cost and in complex geometry using the hot pressing processes described from the literature, coatings are preferably used. The process does not allow for production of ceramic layers via hot pressing. Coatings are produced via the CVD process, for example. Dense layers of a few micrometres are deposited onto a substrate via the gas phase. An example of this would be TaC coatings with a single-layer structure. However, this cost-intensive method prevents coated components with any geometries and sizes from being realized with an arbitrary layer thickness. To ensure greater flexibility in these areas, there is the option of applying the coatings to the substrate via a wet ceramic process (dipping, brushing or spraying). This can be achieved, for example, via a suspension based on organic solvents (see, for example, US 2013/0061800 A1). To produce the desired protective coating properties, a sintering process is added downstream of the application process via an initial suspension.

In addition to the generation of a mechanically stable coating by the final sintering process (high abrasion and adhesion resistance), a high degree of compaction is required at the same time in order to optimally protect the substrate from corrosive media in high-temperature applications. In addition to the requirement for a high degree of densification, it is also required that the formation of cracks in the coating after the sintering process is reduced to a minimum in order to ultimately ensure the protective coating properties of the refractory metal carbide coating and to maximally protect the base substrate from corrosive media in the high-temperature application. Cracks can occur during the sintering process, e.g. during the compaction or shrinkage process or also during cooling. The shrinkage cracks can be avoided by the fact that the applied green sheet show a uniform or homogeneously thick course and thus a uniform compaction can take place. In the case of inhomogeneities in the layer course (such as depressions), shrinkage cracks easily form, which can spread vertically or laterally in the further course of the sintering process or later also under operating conditions. Cracking during cooling is due to the release of excessive thermal tensile stresses induced by the usually large difference in thermal expansion coefficient between the refractory metal carbide coating and the base substrate.

However, obtaining a homogeneous coating pattern in the suspension-based coating of porous substrates, such as CFC substrates, with refractory metal carbide coatings is hampered by the strong infiltration behaviour of the porous substrates and the resulting infiltration of the pores by the suspension, thus leading to an inhomogeneous pattern of the refractory metal carbide coatings.

Based on this, it was the object of the present invention to provide a method for preparing coated substrates, with which substrates can be obtained with a refractory metal carbide coating that is as homogeneous as possible. In addition, it was the object of the present invention to provide coated substrates that have a refractory metal carbide coating that is as homogeneous as possible.

This object is solved with respect to a method for producing coated substrates having the features of patent claim 1 and with respect to a coated substrate having the features of patent claim 12. In claim 15, possible uses of the coated substrate according to the invention are indicated. The dependent claims represent advantageous further developments.

According to the invention, there is thus disclosed a method for preparing coated substrates in which
a) at least one aqueous suspension is prepared which comprises water, at least one agglomerate former and particles of at least one refractory metal carbide, the particles of the at least one refractory metal carbide forming agglomerates in the aqueous suspension,
b) the at least one aqueous suspension is applied to a porous substrate, and
c) the substrate is subjected to a sintering process after step b),
the diameter of each of the agglomerates being greater than the pore entrance diameter of each of the pores of the porous substrate.

In step a) of the method according to the invention, at least one aqueous suspension is first prepared. The at least one aqueous suspension comprises water, at least one agglomerate former, and particles of at least one refractory metal carbide. In this context, an agglomerate former can be understood as a substance that influences the formation of agglomerates. Preferably, the at least one agglomerate former is selected from the group consisting of tetrabutylammonium hydroxide, polyvinyl alcohols, and mixtures thereof. The at least one aqueous suspension may also consist of water, at least one agglomerate former, and particles of at least one refractory metal carbide. Preferably, the at least one refractory metal carbide is tantalum carbide.

In step b) of the method according to the invention, the at least one aqueous suspension (prepared in step a)) is applied to a porous substrate. The at least one aqueous suspension may be applied to one or more sub-areas (for example, one or more surfaces) of the porous substrate or to the entire porous substrate (or the entire surface of the porous substrate). The at least one aqueous suspension may be applied to the porous substrate in a layered manner. The layer (or layers) of the at least one aqueous suspension so applied may be referred to as the green sheet (or green sheets). Preferably, in step b), at least one layer of the at least one aqueous suspension is applied to the porous substrate.

Preferably, step b) is performed directly after step a).

The porous substrate may preferably be a carbon substrate, more preferably a graphite substrate, most preferably an iso-graphite substrate. In this context, iso-graphite is understood to mean graphite produced by the isostatic pressing process. For example, the porous substrate may be a crucible, preferably a carbon crucible, more preferably a graphite crucible, most preferably an iso-graphite crucible.

Preferably, the pores of the porous substrate have an average pore entrance diameter in the range from 0.1 μm to 5 μm, preferably from 0.5 μm to 5 μm, (preferably at the surface). The mean pore entrance diameter (preferably at the surface) can be determined, for example, by mercury intrusion (DIN 66133:1993-06) or by mercury porosimetry (DIN 15901-1:2019-03).

Preferably, the porous substrate has an open porosity in the range of 5% to 20%. The open porosity can be determined, for example, by means of mercury intrusion (DIN 66133:1993-06).

In step c) of the method according to the invention, the substrate is subjected to a sintering process after step b). By the sintering process, at least one protective layer containing the at least one refractory metal carbide can be produced from the at least one aqueous suspension (applied in step b)). In other words, the at least one aqueous suspension (applied in step b)) can be converted by the sintering process into a protective layer containing the at least one refractory metal carbide.

The method according to the invention enables the production of refractory metal carbide-based coatings on substrates that can serve as high-temperature and wear-resistant coatings or wear-resistant coating systems.

The method according to the invention is a wet ceramic process for the production of refractory metal carbide-based coatings on substrates. In contrast to coatings prepared via CVD or PVD processes, coatings prepared via wet ceramic processes exhibit an isotropic texture with random grain size orientation, resulting in reduced susceptibility to cracking and increased diffusion path for substrate-damaging species. Due to this, the coated substrates produced according to the invention exhibit improved protection against aggressive substances used in high-temperature applications compared to coated substrates produced via CVD or PVD processes. In addition, the wet ceramic process according to the invention is less expensive than CVD or PVD processes and also offers more flexibility in the geometries and sizes of the coated components that can be produced, as well as the layer thicknesses of the coatings or layers applied.

Furthermore, the method for producing coated substrates according to the invention is based on the use of an aqueous suspension. Compared to the use of organic suspensions, the use of aqueous suspensions has various advantages. Thus, in contrast to organic suspensions, aqueous suspensions are inexpensive, harmless from an ecological and health point of view, and also do not entail the safety-related problem of easily flammable spray mists. In addition, the use of aqueous suspensions eliminates the need for pyrolysis to remove organic solvents, which can lead to an undesirable introduction of foreign substances into the coating. Furthermore, in contrast to the use of the known organic suspensions, the use of aqueous suspensions allows for controlled application of the suspension. In particular, spray application of the known organic suspensions does not allow controlled application, since the suspension properties can fluctuate during this process due to evaporation of the solvent, so that homogeneous layers cannot be obtained over time.

Due to the sintering process, the protective coating obtained in the method according to the invention is a mechanically stable coating with high abrasion and adhesion resistance. In addition, the sintering process results in a higher degree of compaction compared to the initial density after application (green density).

The presence of the at least one agglomerate former in the at least one aqueous suspension promotes controlled formation of agglomerates of the refractory metal carbide particles in the at least one aqueous suspension. The main result is that the particles do not agglomerate in an uncontrolled manner, but instead agglomerates are formed in a relatively narrow size range, i.e. agglomerates that all have a similar size. A narrow size range of the formed agglomerates can be used to ensure that the size of individual formed agglomerates does not differ too much from the average size of the formed agglomerates. In this way, it can be prevented that individual of the formed agglomerates have too small a diameter.

With the aid of the agglomerate former, the size of the agglomerates or the size range of the agglomerates can also be specifically controlled and adjusted, since the size or size range of the agglomerates depends on the percentage by weight of the agglomerate former in the aqueous suspension. The higher the weight percentage of the agglomerate former, the smaller the diameter of the agglomerates. Preferably, the at least one aqueous suspension contains 0.1 to 2% by weight, more preferably 0.1 to 1% by weight, of the at least one agglomerate former, based on the total weight of the aqueous suspension. With such a proportion of agglomerate former, relatively large agglomerates (i.e. agglomerates with a relatively large diameter) can be obtained in a relatively narrow size range.

Depending on the stability of the individual particles in suspension, which is influenced by the targeted addition of an agglomerate former, the agglomerate size can be specifically adjusted, also measured by the standing time of the suspension. The longer the standing time of the suspension, the better the individual particles are stabilized and the smaller the agglomerates. Without the specific addition of an agglomerate former, the uncontrolled and strong agglomeration makes spraying of the suspension hardly possible or only possible for a very short time.

According to the invention, the diameter of each of the agglomerates is larger than the pore entrance diameter of each of the pores of the porous substrate. This ensures that none of the agglomerates can enter any of the pores of the porous substrate. As a result, the at least one refractory metal carbide can be prevented from entering the pores of the substrate when the at least one aqueous suspension is applied to the porous substrate, ultimately resulting in the formation of a homogeneous protective layer.

If the refractory metal carbide or the agglomerates of the refractory metal carbide particles were to enter the pores of the porous substrate, this would lead to inhomogeneities within the layer. In the case of such inhomogeneities in the course of the layer (such as depressions), shrinkage cracks easily form, which can propagate vertically or laterally in the further course of the sintering process or later also under service conditions. Cracking during cooling is due to the release of excessive thermal tensile stresses induced by the usually large difference in thermal expansion coefficient between the refractory metal carbide coating and the (e.g. carbon-based) base substrate.

The controlled agglomerate formation provided in the method of the invention, in which the diameter of each of the agglomerates is larger than the pore entrance diameter of each of the pores of the porous substrate, now makes it possible to obtain a very homogeneous (or uniform) coating, since penetration of the refractory metal carbide into the pores of the porous substrate can be prevented. Due to the very homogeneous (or even) course of the layer, shrinkage cracks within the protective layer can be avoided. This is also the case because the uniform or homogeneous course of the layer allows uniform compaction to take place. The fewer shrinkage cracks there are in the protective layer obtained, the better the substrate is protected by the protective layer (e.g. from corrosive media in high-temperature applications). Thus, by the process according to the invention, a very homogeneous and only slightly cracked (or even crack-free) refractory metal carbide protective layer can be obtained, which can effectively protect the substrate from foreign influences (such as corrosive media in high-temperature applications).

Using SEM images on the fabricated coated substrate, it can be demonstrated that the pores of the coated substrate are unfilled and none of the agglomerates of the particles of the at least one refractory metal carbide have entered the pores of the substrate. From this, it can be concluded that the diameter of each of the agglomerates is larger than the pore entrance diameter of each of the pores of the porous substrate. Thus, by means of SEM images, the presence of the feature that the diameter of each of the agglomerates is larger than the pore entrance diameter of each of the pores of the porous substrate can be demonstrated.

Preferably, in step b), at least one layer of the at least one aqueous suspension is applied to the porous substrate. The at least one layer of the at least one aqueous suspension may be referred to as the at least one green sheet. The green sheet(s) may show a uniform or homogeneously thick course.

The coated substrate that can be produced by the method according to the invention can be used, for example, as a gallium evaporator or part of a gallium evaporator in a VPE GaN reactor that can be used for growing gallium nitride semiconductor crystals, with the layer system obtained in the process according to the invention then acting as a coating for the gallium evaporator.

A preferred variant of the method according to the invention is characterized in that
the porous substrate contains or consists of a material selected from the group consisting of graphite, preferably iso-graphite, carbon fiber reinforced carbon (CFC), C/SiC fiber composites, SiC/SiC fiber composites, carbidic ceramics, nitridic ceramics, oxidic ceramics, and mixtures thereof, and/or
the at least one refractory metal carbide is selected from the group consisting of titanium carbides, zirconium carbides, hafnium carbides, vanadium carbides, niobium carbides, tantalum carbides, chromium carbides, molybdenum carbides, tungsten carbides, and mixtures thereof, and/or
the at least one agglomerate former is selected from the group consisting of polyvinyl alcohols; polyacrylic acids; polyvinylpyrrolidones; polyalkylene gly-colethers; bases, preferably tetrabutylammonium hydroxide, tetramethylammonium hydroxide, polyethyleneimines, inorganic bases (e.g. NaOH, ammonium hydroxide); and mixtures thereof, wherein the at least one agglomerate former is particularly preferably selected from the group consisting of tetrabutylammonium hydroxide, polyvinyl alcohols and mixtures thereof.

Particularly preferably, the at least one refractory metal carbide is tantalum carbide. Tantalum carbide enables a particularly good protective effect for the porous substrate.

The porous substrate may preferably include or consist of a material selected from the group consisting of graphite, preferably iso-graphite, carbidic ceramics, nitridic ceramics, oxidic ceramics, and mixtures thereof.

The porous substrate may preferably contain or consist of a material selected from the group consisting of graphite, preferably iso-graphite, carbon fiber reinforced carbon (CFC), C/SiC fiber composites, SiC/SiC fiber composites, and mixtures thereof.

Carbon-based substrates and SiC-based substrates show increased infiltration behaviour when an aqueous suspension is applied. As a consequence, the method according to the invention is particularly suitable for such substrates.

Most preferably, the porous substrate contains or consists of graphite, preferably iso-graphite.

Agglomerate formers selected from the group consisting of polyvinyl alcohols; polyacrylic acids; polyvinylpyrrolidones; bases, preferably tetrabutylammonium hydroxide, tetramethylammonium hydroxide, polyethyleneimines, inorganic bases (e.g. NaOH); and mixtures thereof are particularly suitable as agglomerate formers in the process according to the invention.

Particularly preferred agglomerating agents are agglomerating agents selected from the group consisting of tetrabutylammonium hydroxide, polyvinyl alcohols and mixtures thereof. With an agglomerate former selected from the group consisting of tetrabutylammonium hydroxide, polyvinyl alcohols and mixtures thereof, a very controlled agglomerate formation can be achieved in which formed agglomerates can have a size in a particularly narrow size range.

Preferably, the pores of the porous substrate have an average pore entrance diameter of at most 1.5 μm, preferably in the range of 0.1 μm to 1.5 μm, particularly preferably in the range of 0.5 μm to 1.5 μm. The mean pore entrance diameter can be determined, for example, by mercury porosimetry (DIN 15901-1:2019-03) or by mercury intrusion (DIN 66133:1993-06). Such a low average pore entrance diameter can better prevent the agglomerates of the refractory metal carbide particles from entering the pores of the porous substrate.

Preferably, the porous substrate contains or consists of a material having an average grain size of at most 5 μm. The average grain size can be determined, for example, by laser diffraction (DIN 13320:2020-01). The average grain size has an influence on the infiltration behaviour of the porous substrate. An average grain size of at most 5 μm can better prevent the agglomerates of the refractory metal carbide particles from entering the pores of the porous substrate.

A further preferred variant of the method in accordance with the invention is characterized in that
the diameter of (each of) the agglomerates is at least 20 μm, preferably at least 10 μm, particularly preferably at least 5 μm, and/or
the pore entrance diameter (of each) of the pores of the porous substrate is at most 19 μm, preferably at most 9 μm, particularly preferably at most 4 μm.

Preferably, the diameter of the agglomerates may be at least 20 μm and the pore entrance diameter of the pores of the porous substrate may be at most 19 μm. Particularly preferably, the diameter of the agglomerates may be at least 10 μm and the pore entrance diameter of the pores of the porous substrate may be at most 9 μm. Very preferably, the diameter of the agglomerates may be at least 5 μm and the pore entrance diameter of the pores of the porous substrate may be at most 4 μm.

The diameters of the agglomerates and the pore entrance diameters of the pores of the porous substrate can be determined, for example, from SEM images.

The determination of the minimum size of the agglomerates can also be done indirectly by determining the pore entrance diameters of the pores of the substrate, since from the fact that none of the pores are filled, it can be concluded that the diameter of the agglomerates must be larger than the pore entrance diameters of the pores of the substrate. In addition, the size of the agglomerates can also be estimated from standing time tests of the specifically prepared suspensions.

According to a further preferred variant of the method according to the invention, the preparation of the at least one aqueous suspension is carried out in step a) by first preparing a mixture containing the components of the aqueous suspension to be prepared and then allowing the mixture to stand without stirring for a standing time of from 3 minutes to 30 minutes, preferably from 5 minutes to 15 minutes, particularly preferably from 5 minutes to 10 minutes.

By allowing the mixture to stand without stirring for a standing time of from 3 minutes to 30 minutes, preferably from 5 minutes to 15 minutes, particularly preferably from 5 minutes to 10 minutes, a particularly stable suspension with agglomerates in a desired narrow size range can be obtained, in which the agglomerates are almost completely stabilized. In this way, it is even easier to prevent the formation of individual agglomerates with diameters smaller than the pore entrance diameters of the pores of the porous substrate.

The at least one aqueous suspension may comprise at least one binder selected from the group consisting of polyethylene glycol, polyvinyl butyral, polyurethanes, chloroprene rubber, phenolic resins, acrylic resins, carboxymethyl celluloses, alginic acid, dextrins, sodium biphenyl-2-yloxides, polyphenyloxide, and mixtures thereof, wherein said at least one binder is particularly preferably selected from the group consisting of sodium biphenyl-2-yl oxides, polyphenyl oxide, and mixtures thereof, wherein the at least one binder may preferably be present in the at least one aqueous suspension at a level of from 0.05 to 1% by weight or from 0.01 to 5% by weight, based on the total weight of the aqueous suspension.

The binder increases the yield point of the particles so that they are kept in suspension during application. As a result, the aqueous suspension applied to the substrate can dry without infiltrating the substrate. This is also a better way to prevent the agglomerates of the refractory metal carbide particles from entering the pores of the porous substrate.

According to a further preferred variant of the method according to the invention, the surface of the porous substrate on which the at least one aqueous suspension is deposited has
a mean roughness value of at most 3 μm, preferably from 0.5 μm to 3 μm, particularly preferably from 1 μm to 3 μm, and/or
has a mean depth of roughness which is at most 12 μm, preferably from 1 μm to 12 μm, particularly preferably from 3 μm to 12 μm.

By using a porous substrate with such a mean roughness value and/or such an mean roughness depth, an even more homogeneous coating can be obtained.

The mean roughness value can be determined, for example, by means of optical interferometry and evaluation according to DIN EN ISO 25178:2016-12.

The mean depth of roughness can be determined, for example, by means of optical interferometry and evaluation according to DIN EN ISO 25178:2016-12.

According to another preferred variant of the method according to the invention, the average particle size of the particles of the at least one refractory metal carbide is larger than the average pore entrance diameter of the pores of the porous substrate. In this way it is achieved that the particles of the at least one refractory metal carbide are by themselves already so large that all or at least a large part of them cannot enter the pores. In this way, it is even easier to prevent the agglomerates of the refractory metal carbide particles from entering the pores of the porous substrate.

Preferably, the pores of the porous substrate have an average pore entrance diameter of at most 1.2 μm, preferably in the range of 0.1 μm to 1.2 μm, more preferably in the range of 0.5 μm to 1.2 μm.

Preferably, the average particle size (d50 value) of the particles of the at least one refractory metal carbide is in the range of 2 μm to 50 μm, preferably in a range of 3 μm to 30 μm.

The mean particle size (d50 value) of the particles of the at least one refractory metal carbide can be determined, for example, by means of laser diffraction (DIN 13320:2020-01).

It is further preferred that
the mean particle size (d50 value) of the particles of the at least one refractory metal carbide is in a range from 0.2 μm to 5 μm, preferably from 0.5 μm to 4 μm, particularly preferably from 0.8 μm to 2.5 μm, and the mean pore entrance diameter of the pores of the porous substrate is at most 1.2 μm, preferably in the range from 0.1 μm to 1.2 μm, particularly preferably in the range from 0.5 μm to 1.2 μm, preferably the substrate containing or consisting of a material having a mean grain size of at most 5 μm, or
the average particle size (d50 value) of the particles of the at least one refractory metal carbide is in a range from 2 μm to 50 μm, preferably in a range from 3 μm to 30 μm, particularly preferably from 5 μm to 20 μm, and the average pore entrance diameter of the pores of the porous substrate is more than 1.2 μm, preferably the substrate containing or consisting of a material having an average grain size of more than 5 μm.

A further preferred variant of the method according to the invention is characterized in that, in addition to the at least one aqueous suspension prepared in step a), at least one further aqueous suspension is prepared which contains the at least one particulate refractory metal carbide and water, and after step b) the at least one further aqueous suspension is applied to the at least one aqueous suspension applied in step b) (e.g. in the form of a layer), wherein the particles of the at least one refractory metal carbide contained in the aqueous suspension prepared in step a) have an average particle diameter in a range from 5 μm to 50 μm and the particles of the at least one refractory metal carbide contained in the further aqueous suspension have an average particle diameter in a range from 0.2 μm to 2 μm. With such a multilayer coating structure, both the homogeneity of the layer thickness of the refractory metal carbide layer(s) can be increased and potential disadvantages in the sintering process can be avoided. Thus, the refractory metal carbide particles with a relatively large diameter in the range of 5 to 50 μm in the layer directly deposited on the substrate can even better prevent the agglomerates of the refractory metal carbide particles from entering the pores of the porous substrate. At the same time, the refractory metal carbide particles with a relatively small diameter in the range of 0.2 to 2 μm in the further layer can achieve that these refractory metal carbide particles can be sintered better, because refractory metal carbide particles with large particle size sinter worse.

A further preferred variant of the method according to the invention is characterized in that the preparation of the at least one aqueous suspension in step a) comprises mixing the components of the at least one aqueous suspension to be prepared with the aid of a dispersing device, the mixing with the aid of the dispersing device preferably being carried out using grinding media and/or over a period of at least 12 hours.

By mixing the components with the aid of a dispersing device, preferably using grinding media, and/or over a period of at least 12 hours, optimum mixing of the aqueous suspension can be achieved, so that inhomogeneities in the distribution and thus in the compaction can be even better avoided. For example, rotational speeds of up to 1 m/s can be used when mixing with the disperser.

According to a further preferred variant of the method according to the invention, the application of the at least one aqueous suspension in step b) is carried out by means of dipping, brushing or spray application. Particularly preferably, the application of the at least one aqueous suspension in step b) is carried out by spray application. Spray application is the preferred choice for the production of one or more thin, fast-drying refractory metal carbide coatings, preferably with layer thicknesses in the range of 20 μm to 80 μm. In this process, a very thin suspension layer can be applied to the surface by rapidly rotating the component through the spray jet. Depending on the solids content of the suspension, this layer can dry quickly to very quickly. Preferred solids contents of the refractory metal carbide powder are greater than or equal to 70% by weight of the total suspension. Each individual layer to be applied should preferably show comparable drying behaviour. In principle, a fast-drying behaviour of the applied suspension layers is preferred, since density differences between refractory metal carbide and sinter additive can lead to inhomogeneity in the distribution of the particles if the layers dry for too long.

According to an exemplary preferred variant, in step b) at least one layer of the aqueous suspension with an average layer thickness of less than 150 μm, preferably from 20 μm to 100 μm, particularly preferably from 30 μm to 80 μm, can be applied to the porous substrate.

According to an alternative exemplary preferred embodiment, at least one layer of the aqueous suspension with an average layer thickness of less than 50 μm, preferably of less than 30 μm, can be applied to the porous substrate in step b).

A further preferred variant of the method according to the invention is characterized in that the at least one aqueous suspension
contains 60 to 90% by weight, preferably 70 to 85% by weight, of the particles of the at least one refractory metal carbide, based on the total weight of the aqueous suspension, and/or
contains 0.1 to 2% by weight, preferably 0.1 to 1% by weight, of the at least one agglomerate former, based on the total weight of the aqueous suspension.

According to a further preferred embodiment, the at least one aqueous suspension may comprise a sintering additive preferably selected from the group consisting of refractory metal silicides, refractory metal nitrides, refractory metal borides, silicon, silicon carbide, boron nitride, tungsten carbide, vanadium carbide, molybdenum carbide, boron carbide and mixtures thereof, wherein the sintering additive is particularly preferably selected from the group consisting of silicon, zirconium boride, refractory metal silicides, and mixtures thereof.

The refractory metal silicides are preferably selected from the group consisting of titanium silicides, zirconium silicides, e.g. zirconium disilicide (ZrSi2), hafnium silicides, e.g. hafnium disilicide (HfSi2), vanadium silicides, e.g. vanadium disilicide (VSi2), niobium silicides, e.g. niobium disilicide (NbSi2), tantalum silicides, e.g. tantalum disilicide (TaSi2), chromium silicides, molybdenum silicides, e.g. molybdenum disilicide (MoSi2), tungsten silicides, e.g. tungsten disilicide (WSi2), and mixtures thereof.

The refractory metal nitrides are preferably selected from the group consisting of titanium nitrides, zirconium nitrides, hafnium nitrides, vanadium nitrides, niobium nitrides, tantalum nitrides, chromium nitrides, molybdenum nitrides, tungsten nitrides, and mixtures thereof.

The refractory metal borides are preferably selected from the group consisting of titanium borides, zirconium borides, hafnium borides, vanadium borides, niobium borides, tantalum borides, chromium borides, molybdenum borides, tungsten borides and mixtures thereof.

These sintering additives have been shown to have at least the same or even a better effect on the degree of densification than the transition metals (e.g. cobalt, nickel, iron, etc.) used as sintering additives in the prior art, due to their properties (e.g. melting points, boiling points, etc.). Thus, a high degree of densification of the sintered layer can be achieved by using them, which protects the substrate very well from corrosive media in high-temperature applications. Compared with the sinter additives used in the prior art, such as cobalt, the sinter additives mentioned are characterized first of all by the fact that they are harmless in terms of safety and health. In addition, their use, and thus the avoidance of specific transition metals, like cobalt, nickel, iron, as sintering additives, prevents these transition metals from remaining as impurities in the coating, which would be detrimental to the growth atmosphere there when the coated substrate is used in high-temperature applications in semiconductor crystal growing.

The method according to any one of the preceding claims, characterized in that the sintering process in step c) takes place
at a temperature of from 2100° C. to 2500° C., preferably from 2200° C. to 2400° C., and/or
with a holding time of 1 hour to 15 hours, preferably of 2 hours to 10 hours, and/or
at a pressure of 0.1 bar to 10 bar, preferably 0.7 bar to 5 bar, and/or 1 under argon atmosphere.

On the one hand, these designs of the sintering process can ensure that the protective coating obtained has a particularly high mechanical stability with a particularly high abrasion and adhesion resistance. In addition, these designs of the sintering process increase the stability of the melt phase throughout the entire sintering process.

The present invention further relates to a coated substrate comprising a porous substrate and at least one layer disposed on the porous substrate comprising or consisting of at least one refractory metal carbide, wherein the at least one layer disposed on the porous substrate comprises a grain structure of isometric grains, and wherein the porous substrate comprises unfilled pores closed by the at least one layer disposed on the porous substrate.

Isometric grains are preferably understood to mean grains with a grain aspect ratio close to or equal to 1. By way of example, the isometric grains may have a grain aspect ratio of at least 0.95, preferably at least 0.95, more preferably at least 0.99, particularly 1.

A grain structure of isometric grains occurs only in coatings obtained by suspension deposition, but not in coatings obtained by CVD processes. Subsequently, the coated substrate according to the invention differs from substrates coated by means of CVD processes due to the grain structure of isometric grains that the at least one layer arranged on the porous substrate has.

By means of SEM images of the coated substrate (or a transverse section thereof), it can be demonstrated that the porous substrate has unfilled pores that are closed by the at least one layer disposed on the porous substrate.

Due to the feature that the porous substrate has unfilled pores closed by the at least one layer disposed on the porous substrate, the at least one layer disposed on the porous substrate can be obtained very homogeneous and only slightly cracked (or even crack-free), so that the at least one layer disposed on the porous substrate can better protect the porous substrate from foreign influences (such as from corrosive media in high temperature applications).

A preferred embodiment of the coated substrate according to the invention is characterized in that the at least one layer arranged on the porous substrate has an mean layer thickness of at least 20 μm, preferably from 20 μm to 150 μm, particularly preferably from 30 μm to 100 μm.

A preferred embodiment of the coated substrate according to the invention is characterized in that the standard deviation of the average layer thickness of the at least one layer arranged on the porous substrate is at most 6%, preferably is in the range of 0.5% to 6%, particularly preferably is in the range of 1% to 6%.

Very preferably, the at least one layer disposed on the porous substrate has a mean layer thickness of at least 20 μm, preferably from 20 μm to 150 μm, particularly preferably from 30 μm to 100 μm, and the standard deviation of the average layer thickness of the at least one layer disposed on the porous substrate is at most 6%, preferably in the range from 0.5% to 6%, particularly preferably in the range from 1% to 6%.

The standard deviation of the average layer thickness is a measure of the homogeneity (or uniformity) of the layer thickness of the coating. The smaller the standard deviation of the average layer thickness of the at least one layer disposed on the porous substrate, the more homogeneous (or uniform) the layer thickness of the at least one layer disposed on the porous substrate.

By means of transverse sections, the optical path of the layer arranged on the porous substrate, which contains or consists of at least one refractory metal carbide, can be displayed and evaluated in a classical manner. Here, a visual observation of the cross-section and the qualitative classification into a homogeneous or inhomogeneous layer system can be performed.

The mean layer thickness of the at least one layer disposed on the porous substrate can also be determined from transverse sections of the coated substrate. Thus, the mean layer thickness is determined by performing a large number of point measurements on the cross-section of the layer, from which a standard deviation can be calculated, which also provides a quantitative assessment of the homogeneity of the layer.

For example, quantification of homogeneity using the standard deviation of the layer thickness is possible in the following way:
preparation of a transverse section of coated substrate (i.e. layer+substrate)
measurement of the distance between interface and layer surface (layer thickness) on the basis of recorded cross-section images
layer thickness analysis in an area with maximum extension of e.g. 4 cm
number of individual layer thickness measurements is at least 25 per 1 cm of measuring area
spacing of individual layer thickness measurements is regular
determination of the standard deviation over all individual layer thickness measurements
for example, with a standard deviation of ≤6%, it can be assumed that the layer in question is homogeneous.

Without having to perform a time-consuming cross-section preparation, a quick qualitative assessment of the homogeneity of the layer can be made on the basis of the top view.

Another preferred embodiment of the coated substrate according to the invention is characterized in that
the porous substrate contains or consists of a material selected from the group consisting of graphite, preferably iso-graphite, carbon fiber reinforced carbon (CFC), C/SiC fiber composites, SiC/SiC fiber composites, carbidic ceramics, nitridic ceramics, oxidic ceramics, and mixtures thereof, and/or
the at least one refractory metal carbide is selected from the group consisting of titanium carbides, zirconium carbides, hafnium carbides, vanadium carbides, niobium carbides, tantalum carbides, chromium carbides, molybdenum carbides, tungsten carbides, and mixtures thereof.

Particularly preferably, the at least one refractory metal carbide is tantalum carbide.

The porous substrate may preferably include or consist of a material selected from the group consisting of graphite, preferably iso-graphite, carbidic ceramics, nitridic ceramics, oxidic ceramics, and mixtures thereof.

The porous substrate may preferably contain or consist of a material selected from the group consisting of graphite, preferably iso-graphite, carbon fiber reinforced carbon (CFC), C/SiC fiber composites, SiC/SiC fiber composites, and mixtures thereof.

Most preferably, the porous substrate contains or consists of graphite, preferably iso-graphite.

The porous substrate may preferably be a carbon substrate, more preferably a graphite substrate, most preferably an iso-graphite substrate. In this context, iso-graphite is understood to mean graphite produced by the isostatic pressing process. For example, the porous substrate may be a crucible, preferably a carbon crucible, more preferably a graphite crucible, most preferably an iso-graphite crucible.

According to another preferred embodiment of the coated substrate according to the invention, the coated substrate comprises at least one further layer, wherein the at least one further layer is arranged directly on the layer arranged on the porous substrate and comprises or consists of at least one refractory metal carbide.

A further preferred embodiment of the coated substrate according to the invention is characterized in that the coated substrate can be produced or is produced by the method according to the invention.

Furthermore, the present invention also relates to the use of the coated substrate according to the invention in semiconductor crystal growing, wherein the coated substrate is preferably a coated crucible.

The present invention will be explained in more detail with reference to the following Figures and examples without restricting the invention to the specifically shown parameters.

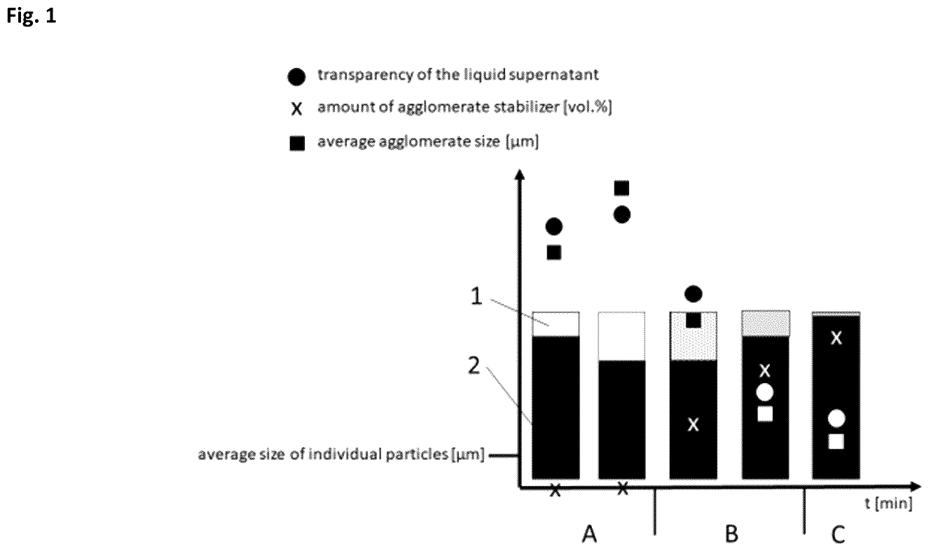

In FIG. 1, the agglomerate formation is explained schematically. Five suspensions containing water and particles of at least one refractory metal carbide are shown there, which have a supernatant 1 and an agglomerate-containing portion 2 and were prepared under different conditions. The three right suspensions in area B and C additionally contain at least one agglomerate former (or agglomerate stabilizer), the proportion of agglomerate former varying. The two suspensions on the left do not contain any agglomerate former. The standing time used in the production of the respective suspension increases from left to right.

Region A shows two suspensions for which no agglomerate former was used in their preparation. Even with a standing time of 1 to max. 2 minutes, uncontrolled, random and strong agglomerate formation with a broad size distribution takes place here. At no time are the individual particles stabilized.

Region B shows two suspensions in the preparation of which an agglomerate former was used at different concentrations. The individual particles are stabilized for a standing time of up to 5 minutes. From a standing time of min. 5 minutes to max. 15 minutes, agglomerate formation takes place specifically in a deliberately narrow size range.

Region C shows a suspension in the preparation of which an agglomerate former was used at a higher concentration than in the two suspensions in region B. Up to a standing time of at least 15 minutes, the individual particles are almost completely stabilized. From a standing time of at least 15 minutes, a small amount of agglomerate formation takes place specifically in a deliberately very narrow size range.

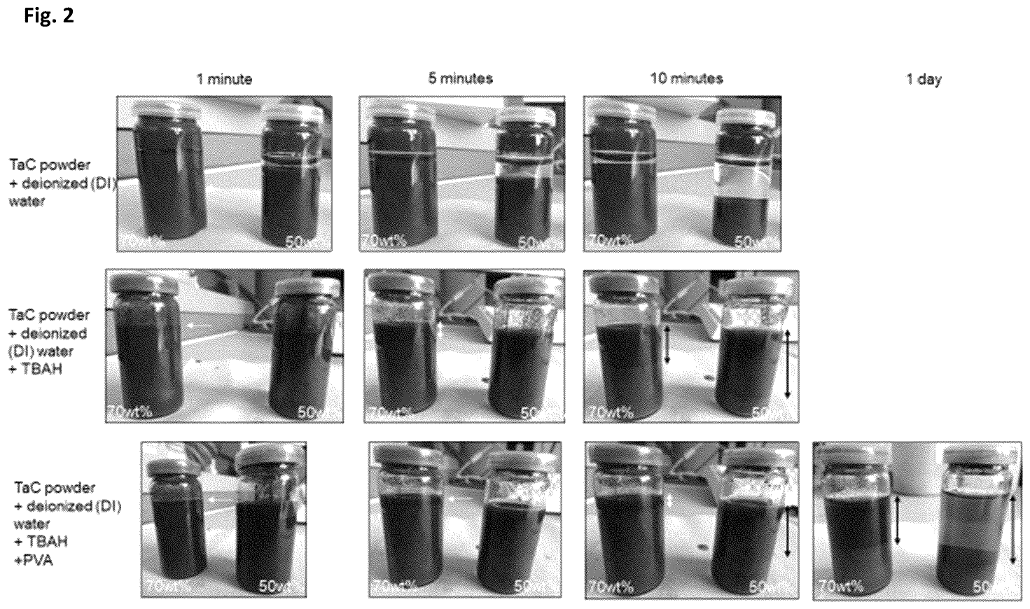

In FIG. 2, photos of suspensions prepared in various ways are shown. The suspensions in the top three photos contain water and tantalum carbide particles. The suspensions in the three photos in the middle row contain water and tantalum carbide particles and additionally tetrabutylammonium hydroxide as agglomerate former. The suspensions in the four photos below contain water and tantalum carbide particles, plus a mixture of tetrabutylammonium hydroxide and polyvinyl alcohol as agglomerate formers. In each of the photos, the left suspension contains 70 wt % tantalum carbide particles and the right suspension contains 50 wt % tantalum carbide particles. The standing time used to prepare the suspension increases from left to right and is indicated above the photos. Depending on the stability of the individual particles in suspension, which is influenced by the targeted addition of an agglomerate former, the agglomerate size, measured by the standing time of the suspension, can be specifically adjusted. The longer the standing time of the suspension, the better the individual particles are stabilized and the smaller the agglomerates. Without the specific addition of an agglomerate former, the uncontrolled and strong agglomeration makes spraying of the suspension hardly possible or only possible for a very short time.

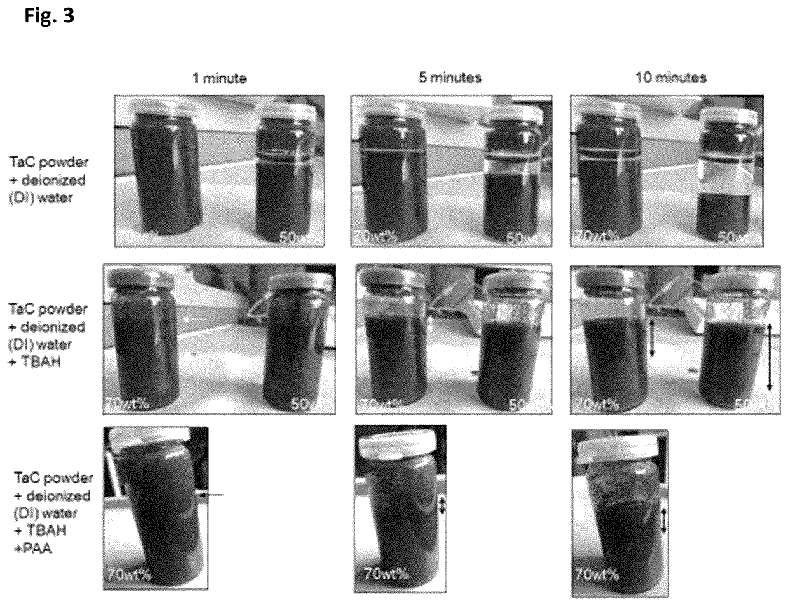

In FIG. 3, photos of suspensions prepared in various ways are shown. The suspensions in the top three photos contain water and tantalum carbide particles. The suspensions in the three photos in the middle row contain water and tantalum carbide particles and additionally tetrabutylammonium hydroxide as agglomerate former. The suspensions in the four photos below contain water and tantalum carbide particles, plus a mixture of tetrabutylammonium hydroxide and polyacrylic acid as agglomerate formers. In each of the photos, the left suspension contains 70 wt % tantalum carbide particles and the right suspension contains 50 wt % tantalum carbide particles. The standing time used to prepare the suspension increases from left to right and is indicated above the photos. Depending on the stability of the individual particles in suspension, which is influenced by the targeted addition of an agglomerate former, the agglomerate size, measured by the standing time of the suspension, can be specifically adjusted. The longer the standing time of the suspension, the better the individual particles are stabilized and the smaller the agglomerates. Without the specific addition of an agglomerate former, the uncontrolled and strong agglomeration makes spraying of the suspension hardly possible or only possible for a very short time.

### EXAMPLE 1

First, an aqueous suspension is prepared by making a mixture consisting of 80 wt % TaC powder, 0.1 wt % tetrabutylammonium hydroxide, 1 wt % polyvinyl alcohol and 18.9 wt % water, and then allowing the mixture to stand for a standing time of 12 minutes without stirring. Here, the TaC particles of the TaC powder form agglomerates in the aqueous suspension. The aqueous suspension prepared in this way is applied in layers to a porous graphite substrate (average pore entrance diameter: 0.6 μm, grain size: 2 μm, Rₐ: 1.5 μm).

Subsequently, the substrate provided with the aqueous suspension is subjected to a sintering process, which takes place at a temperature of 2300° C., with a holding time of 10 h and at a pressure of 1 bar.

In this way, a coated graphite substrate is obtained comprising a porous graphite substrate and a TaC protective layer disposed thereon. The TaC layer has a grain structure of isometric grains.

A transverse section of the coated substrate is made to examine the coated substrate. An image of this cross-section is shown in FIG. 4.

By means of an SEM image of the cross-section, it can be determined that the pores of the porous substrate are unfilled and closed by the TaC layer. From this it can be deduced that none of the agglomerates of the aqueous suspension entered the pores of the porous substrate, and thus each of the agglomerates is larger than the pore entrance diameter of each of the pores of the porous substrate.

Furthermore, the cross-section is used to determine the mean layer thickness of the TaC layer and the standard deviation of the average layer thickness. For this purpose, individual measurements are made at at least 25 measuring points per 1 cm of measuring area of the layer by measuring the distance between the interface and the layer surface (layer thickness) on the basis of recorded cross-section images, with regular distances between the individual measuring points. In this way, a value of 55.9 μm is determined for the mean layer thickness of the TaC layer. In addition, a standard deviation over all individual layer thickness measurements of 2.5 μm (4.5%) is determined.

Since the standard deviation does not exceed 6%, the TaC layer is therefore a homogeneous layer.

### EXAMPLE 2

First, an aqueous suspension is prepared by making a mixture consisting of 80 wt % TaC powder, 0.1 wt % tetrabutylammonium hydroxide, 1 wt % polyvinyl alcohol and 18.9 wt % water, and then allowing the mixture to stand for a standing time of 12 minutes without stirring. Here, the TaC particles of the TaC powder form agglomerates in the aqueous suspension. The aqueous suspension prepared in this way is applied in layers to a porous graphite substrate (average pore entrance diameter: 0.6 μm, grain size: 3 μm, Rₐ: 1.5 μm). Subsequently, the substrate provided with the aqueous suspension is subjected to a sintering process, which takes place at a temperature of 2300° C., with a holding time of 10 h and at a pressure of 1 bar.

In this way, a coated graphite substrate is obtained comprising a porous graphite substrate and a TaC protective layer disposed thereon. The TaC layer has a grain structure of isometric grains.

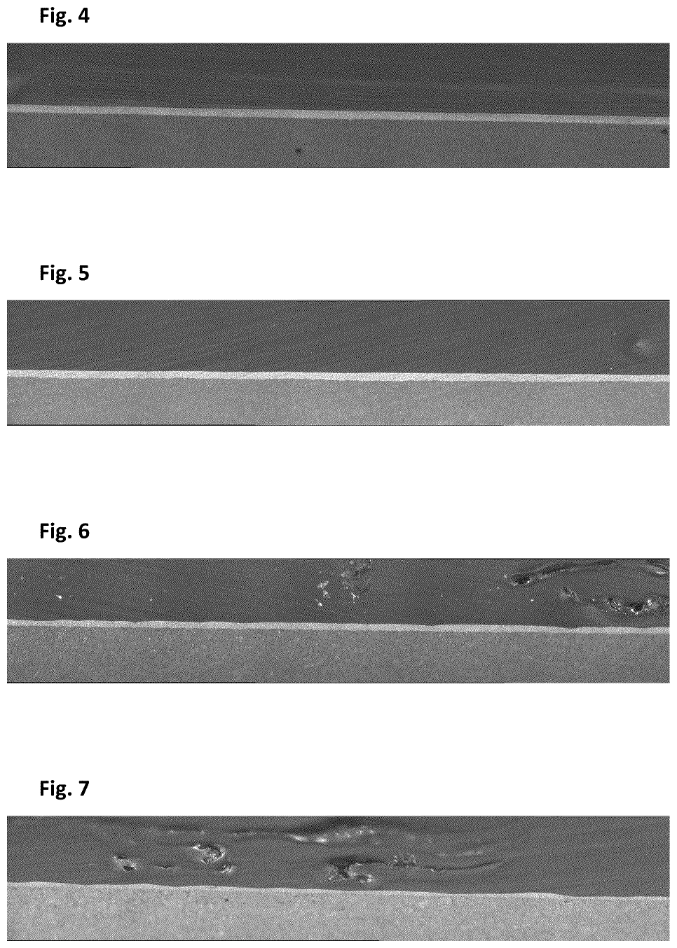

A transverse section of the coated substrate is made to examine the coated substrate. An image of this cross-section is shown in FIG. 5.

By means of an SEM image of the cross-section, it can be determined that the pores of the porous substrate are unfilled and closed by the TaC layer. From this it can be deduced that none of the agglomerates of the aqueous suspension entered the pores of the porous substrate, and thus each of the agglomerates is larger than the pore entrance diameter of each of the pores of the porous substrate.

Furthermore, the cross-section is used to determine the mean layer thickness of the TaC layer and the standard deviation of the average layer thickness. For this purpose, individual measurements are made at at least 25 measuring points per 1 cm of measuring area of the layer by measuring the distance between the interface and the layer surface (layer thickness) on the basis of recorded cross-section images, with regular distances between the individual measuring points. In this way, a value of 50.9 μm is determined for the mean layer thickness of the TaC layer. In addition, a standard deviation of 2.7 μm (5.3%) is determined over all individual layer thickness measurements.

Since the standard deviation does not exceed 6%, the TaC layer is therefore a homogeneous layer.

### EXAMPLE 3

First, an aqueous suspension is prepared by making a mixture consisting of 80 wt % TaC powder, 0.1 wt % tetrabutylammonium hydroxide, 0.5 wt % polyacrylic acid and 19.4 wt % water, and then allowing the mixture to stand for a standing time of 8 minutes without stirring. Here, the TaC particles of the TaC powder form agglomerates in the aqueous suspension. The aqueous suspension prepared in this way is applied in layers to a porous graphite substrate (average pore entrance diameter: 0.6 μm, grain size: 2 μm, Rₐ: 1.5 μm). Subsequently, the substrate provided with the aqueous suspension is subjected to a sintering process, which takes place at a temperature of 2300° C., with a holding time of 10 h and at a pressure of 1 bar.

In this way, a coated graphite substrate is obtained comprising a porous graphite substrate and a TaC protective layer disposed thereon. The TaC layer has a grain structure of isometric grains.

Furthermore, a contact-free layer thickness measurement is used to determine the mean layer thickness of the TaC layer and the standard deviation of the average layer thickness. In this way, a value of 48.6 μm is determined for the mean layer thickness of the TaC layer. In addition, a standard deviation over all individual layer thickness measurements of 2.1 μm (4.3%) is determined.

Since the standard deviation does not exceed 6%, the TaC layer is therefore a homogeneous layer.

### Comparison Example 1

First, an aqueous suspension is prepared by making a mixture consisting of 80 wt % TaC powder, 1 wt % polyvinyl alcohol and 19 wt % water, and then allowing the mixture to stand for a standing time of 8 minutes without stirring. Here, the TaC particles of the TaC powder form agglomerates in the aqueous suspension. The aqueous suspension prepared in this way is applied in layers to a porous graphite substrate (average pore entrance diameter: 1.8 μm, grain size: 10 μm, Rₐ: 1.5 μm). Subsequently, the substrate provided with the aqueous suspension is subjected to a sintering process, which takes place at a temperature of 2300° C., with a holding time of 10 h and at a pressure of 1 bar.

In this way, a coated graphite substrate is obtained comprising a porous graphite substrate and a TaC protective layer disposed thereon. The TaC layer has a grain structure of isometric grains.

A transverse section of the coated substrate is made to examine the coated substrate. An image of this cross-section is shown in FIG. 6.

By means of an SEM image of the transverse section, it can be determined that the pores of the porous substrate are partially filled with the material of the TaC layer. From this, it can be inferred that agglomerates of the aqueous suspension have entered the pores of the porous substrate and thus not each of the agglomerates is larger than the pore entrance diameter of each of the pores of the porous substrate. Compared with embodiments 1 and 2, this is due in particular to the fact that the graphite substrate used in comparison example 1 has larger pores and thus larger pore entrance diameters.

Furthermore, the cross-section is used to determine the mean layer thickness of the TaC layer and the standard deviation of the average layer thickness. For this purpose, individual measurements are made at at least 25 measuring points per 1 cm of measuring area of the layer by measuring the distance between the interface and the layer surface (layer thickness) on the basis of recorded cross-section images, with regular distances between the individual measuring points. In this way, a value of 44.7 μm is determined for the mean layer thickness of the TaC layer. In addition, a standard deviation of 5.3 μm (11.8%) is determined over all individual layer thickness measurements.

Since the standard deviation is more than 6%, the TaC layer is therefore an inhomogeneous layer.

### Comparison Example 2

First, an aqueous suspension is prepared by making a mixture consisting of 80 wt % TaC powder, 1 wt % polyvinyl alcohol and 19 wt % water, and then allowing the mixture to stand for a standing time of 8 minutes without stirring. Here, the TaC particles of the TaC powder form agglomerates in the aqueous suspension. The aqueous suspension prepared in this way is applied in layers to a porous graphite substrate (average pore entrance diameter: 3.3 μm, grain size: 20 μm, Rₐ: 1.5 μm). Subsequently, the substrate provided with the aqueous suspension is subjected to a sintering process, which takes place at a temperature of 2300° C., with a holding time of 10 h and at a pressure of 1 bar.

In this way, a coated graphite substrate is obtained comprising a porous graphite substrate and a TaC protective layer disposed thereon. The TaC layer has a grain structure of isometric grains.

A transverse section of the coated substrate is made to examine the coated substrate. An image of this cross-section is shown in FIG. 7.

By means of an SEM image of the transverse section, it can be determined that the pores of the porous substrate are partially filled with the material of the TaC layer. From this, it can be inferred that agglomerates of the aqueous suspension have entered the pores of the porous substrate and thus not each of the agglomerates is larger than the pore entrance diameter of each of the pores of the porous substrate. Compared with embodiments 1 and 2, this is due in particular to the fact that the graphite substrate used in comparison example 2 has larger pores and thus larger pore entrance diameters.

Furthermore, the cross-section is used to determine the mean layer thickness of the TaC layer and the standard deviation of the average layer thickness. For this purpose, individual measurements are made at at least 25 measuring points per 1 cm of measuring area of the layer by measuring the distance between the interface and the layer surface (layer thickness) on the basis of recorded cross-section images, with regular distances between the individual measuring points. In this way, a value of 30.7 μm is determined for the mean layer thickness of the TaC layer. In addition, a standard deviation over all individual layer thickness measurements of 5.5 μm (18%) is determined.

Since the standard deviation is more than 6%, the TaC layer is therefore an inhomogeneous layer.

1-15. (canceled)

16. A method for preparing a coated substrate wherein:
a) at least one aqueous suspension is prepared, the aqueous suspension containing water, at least one agglomerate former, and particles of at least one refractory metal carbide, the particles of the at least one refractory metal carbide forming agglomerates in the at least one aqueous suspension,
b) the at least one aqueous suspension is applied to a porous substrate, and
c) the substrate is subjected to a sintering process after step b),
wherein the diameter of each of the agglomerates is greater than a pore entrance diameter of each of the pores of the porous substrate.

17. The method according to claim 16, wherein
the porous substrate contains a material selected from the group consisting of graphite, carbon fiber reinforced carbon (CFC), C/SiC fiber composite, SiC/SiC fiber composite, carbidic ceramic, nitridic ceramic, oxidic ceramic, and mixtures thereof, and/or
the at least one refractory metal carbide is selected from the group consisting of titanium carbide, zirconium carbide, hafnium carbide, vanadium carbide, niobium carbide, tantalum carbide, chromium carbide, molybdenum carbide, and tungsten carbide, and/or
the at least one agglomerate former is selected from the group consisting of polyvinyl alcohol, polyacrylic acid, polyvinylpyrrolidone, polyalkylene glycol ether, polyvinyl alcohol, and a base.

18. The method according to claim 17, wherein the base is selected from the group consisting of tetrabutylammonium hydroxide, tetramethylammonium hydroxide, polyethyleneimine, inorganic base, and mixtures thereof.

19. The method according to claim 16, wherein
the diameter of the agglomerates is at least 20 μm, and/or
the pore entrance diameter of the pores of the porous substrate is at most 19 μm.

20. The method according to claim 16, wherein the at least one aqueous suspension is prepared in step a) by first preparing a mixture containing the components of the aqueous suspension to be prepared and allowing the mixture to stand for a standing time of 3 minutes to 30 minutes without stirring.

21. The method according to claim 16, wherein the at least one aqueous suspension contains 0.05 to 1% by weight of at least one binder, based on the total weight of the aqueous suspension, wherein the at least one binder is selected from the group consisting of polyethylene glycol, polyvinyl butyral, polyurethanes, chloroprene rubber, phenolic resins, acrylic resins, carboxymethyl celluloses, alginic acid, dextrins, sodium biphenyl-2-yloxides, and polyphenyloxide.

22. The method according to claim 16, wherein the at least one aqueous suspension contains 0.05 to 1% by weight of at least one binder, based on the total weight of the aqueous suspension, wherein the at least one binder is selected from the group consisting of consisting of polyvinyl alcohol and sodium biphenyl-2-yl oxide.

23. The method according to claim 16, wherein the surface of the porous substrate on which the at least one aqueous suspension is deposited has a mean roughness value of at most 3 μm and/or has a mean depth of roughness of at most 12 μm.

24. The method according to claim 16, wherein the mean particle size of the particles of the at least one refractory metal carbide is greater than the mean pore entrance diameter of the pores of the porous substrate.

25. The method according to claim 16, wherein the preparation of the at least one aqueous suspension in step a) comprises mixing the components of the at least one aqueous suspension to be prepared with the aid of a dispersing device.

26. The method according to claim 16, wherein the at least one aqueous suspension is applied in step b) by dipping, brushing, or spray application.

27. The method according to claim 16, wherein the at least one aqueous suspension
contains 60 to 90% by weight of the particles of the at least one refractory metal carbide, based on the total weight of the aqueous suspension, and/or
0.1 to 2% by weight of the at least one agglomerate former, based on the total weight of the aqueous suspension.

28. The method according to claim 16, wherein the sintering process in step c) takes place
at a temperature of from 2100° C. to 2500° C., and/or
with a holding time of 1 hour to 15 hours, and/or
at a pressure of 0.1 bar to 10 bar.

29. A coated substrate comprising a porous substrate and at least one layer arranged on the porous substrate, wherein the at least one layer arranged on the porous substrate contains at least one refractory metal carbide, the at least one layer arranged on the porous substrate has a grain structure of isometric grains, and the porous substrate has unfilled pores closed by the at least one layer arranged on the porous substrate.

30. The coated substrate according to claim 29, wherein
the at least one layer arranged on the porous substrate has a mean layer thickness of at least 20 μm, and/or
the standard deviation of the mean layer thickness of the at least one layer arranged on the porous substrate is at most 6%.

31. The coated substrate prepared by method according to claim 16.

32. A method of growing a semiconductor crystal in a coated substrate according to claim 27, wherein the coated substrate is a coated crucible.
